(19) United States
(12) Patent Application Publication
(10) Pub. No.: US 2025/0094989 A1
(43) Pub. Date: Mar. 20, 2025

(54) Cross-Cluster Transaction Risk Assessment

(71) Applicant: Oracle International Corporation, Redwood Shores, CA (US)

(72) Inventors: Venkatakrishnan Gopalakrishnan, Ontario (CA); Jan Sterba, Bratislava (SK); Diego Ceferino Torres Dho, Barcelona (ES); May Bich Nhi Lam, San Jose, CA (US)

(73) Assignee: Oracle International Corporation, Redwood Shores, CA (US)

(21) Appl. No.: 18/470,196

(22) Filed: Sep. 19, 2023

(51) Int. Cl. G06Q 20/40; G06Q 20/38

(52) U.S. Cl. CPC G06Q 20/4016; G06Q 20/389

(57) ABSTRACT

Techniques for providing cross-cluster transaction risk assessment are disclosed herein. In one embodiment, the system: obtains customer transaction data including a number of transaction details; clusters the customer transaction data into clusters of transactions; calculates a centroid for each cluster of transactions, corresponding to a mean value within the corresponding cluster; determines, for each transaction, a relationship score indicating the distance of the transaction from the centroid of its cluster; clusters transactions across multiple customers within a posting period to determine a centroid for each customer; calculates a risk score for each transaction by evaluating the transaction's relationship scores against the centroid of the corresponding cluster and the centroids of the other clusters; assigns a risk flag to transactions having risk scores exceeding one or more predefined risk thresholds; and presents one or more notifications of the transactions with risk flags to one or more client devices associated with users.

### TECHNICAL FIELD

The present disclosure relates to transaction monitoring in database systems and methods for providing cross-cluster transaction risk assessment.

### BACKGROUND

The evaluation of transaction-related risks is of paramount importance to ensure the stability and security of database operations. Various industries, from financial institutions to e-commerce platforms, heavily rely on effective risk assessment systems. These systems traditionally serve as indispensable tools for upholding financial integrity, regulatory compliance, and operational efficiency.

Over time, various methods and technologies have been developed with the aim of detecting transaction risks. These approaches include, for example, the utilization of statistical models, rule-based systems, and supervised learning algorithms. Such methods have enhanced risk assessment processes by providing valuable insights into transaction behaviors and patterns.

Nevertheless, the current state of the art possesses significant limitations. Conventional approaches to transaction risk assessment grapple with challenges in adapting to the ever-evolving dynamics of contemporary transactions. These challenges include scalability issues related to processing large volumes of transaction data efficiently. Furthermore, they struggle with maintaining accuracy in identifying emerging risks and unforeseen anomalies, often relying on static rule-based systems that may not adapt well to evolving transaction patterns.

Additionally, many of these systems lack the capability to contextualize transactions within a broader framework, such as, e.g., understanding the relationship between transactions of different customers, or accounting for seasonal fluctuations. This limited contextual understanding restricts their effectiveness in proactive risk management.

Moreover, supervised learning systems, while effective in certain contexts, require resource-intensive human oversight and manual labeling of data, which can be financially burdensome and time-consuming, particularly for industries with high transaction volumes.

These limitations underscore the need for innovative transaction risk assessment methods and systems that offer a more precise, scalable, and adaptable approach to recognizing and assessing transaction risks.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with some embodiments;

FIG. 2 illustrates an example set of operations for providing cross-cluster transaction risk assessment;

FIG. 3 illustrates an example diagram of a risk assessment process being performed for a set of transactions in accordance with some embodiments;

FIG. 4 illustrates a computer system upon which some embodiments may be implemented.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.

### 1. General Overview

Techniques are described herein for performing cross-cluster transaction risk assessment. The proposed systems and methods leverage advanced clustering and centroid calculation techniques to group transactions into meaningful clusters across customers, allowing for a more nuanced understanding of transaction patterns. These clusters are not only based on individual transaction attributes, but also consider contextual information and trends across customers for a particular posting period. By calculating relationship scores and risk flags for each transaction within these clusters, various embodiments provide a comprehensive and adaptive risk assessment framework. The result is a more accurate identification of risky transactions while mitigating the impact of external factors on the risk assessment process.

In some embodiments, a transaction risk assessment process identifies transaction risk associated with customers through various methodologies. Transactions that are deemed risky are flagged, and customers are notified of the risk assessed for them. Transactions that are considered to be anomalous, when taken in the context of other transactions during a given time period, are assigned a higher risk score than other transactions which are not considered anomalous. The process assess risk and performs anomaly detection for transaction not just within a single customer's set of transaction for the time period.

In some embodiments, given a pool of transactions and a pool of customers, the process clusters transactions separately for each customer in the given posting period. Within these clusters, centroids are calculated, essentially pinpointing typical transaction behavior. For each transaction, a relationship score is determined, highlighting its proximity to the cluster's centroid. The process then considers the context and relationship of transactions across the pool of customers for that posting period when determining a risk associated with each transaction for each customer. This helps to assess risk based on factors which may be affecting all the customers over this period of time.

Thus, in some embodiments, for a pool of transactions and a pool of customers, the process assesses transactional risk for each transaction and for every relationship between that transaction and the other transactions. Risk is assessed on a per-transactional basis, as well as for relationships between transactions within and across clusters in the pool of customers. This enables an anomaly to be detected for a transaction only if it does not belong in any cluster, i.e., there are no similar transactions to it within its cluster or across different clusters. Transactions that exceed predefined risk thresholds are flagged, and notifications are promptly presented to users through client devices.

One or more embodiments described in this Specification and/or recited in the claims may not be included in this General Overview section.

### 2. Architectural Overview

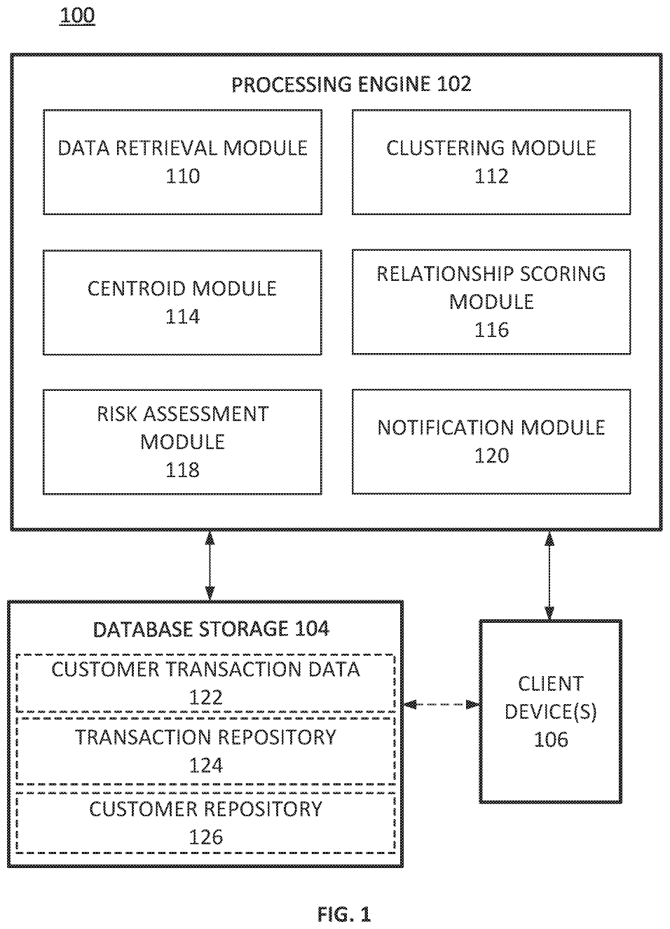

FIG. 1 illustrates an exemplary system 100 in accordance with some embodiments. As illustrated in FIG. 1, the system 100 includes processing engine 102, database storage 104, and client device(s) 106. In the system 100, one or more client device(s) 106 are connected to a processing engine 102 and a database storage 104. The processing engine 102 is connected to the database storage 104, and optionally connected to one or more repositories and/or databases, including, e.g., a customer transaction data repository 122, a transaction repository 132, and/or a customer repository 134. One or more of the databases may be combined or split into multiple databases. The client device(s) 106 in this environment may be one or more computers, and the processing engine 102 may be an application or software hosted on a computer or multiple computers which are communicatively coupled via remote server or locally.

In one or more embodiments, system 100 may include more or fewer components than the components illustrated in FIG. 1. The components illustrated in FIG. 1 may be local to or remote from each other. The components of processing engine 102, database storage 104, and/or client device(s) 106 may be distributed over multiple applications and/or machines. Multiple components may be combined into one application and/or machine. Operations described with respect to one component may instead be performed by another component.

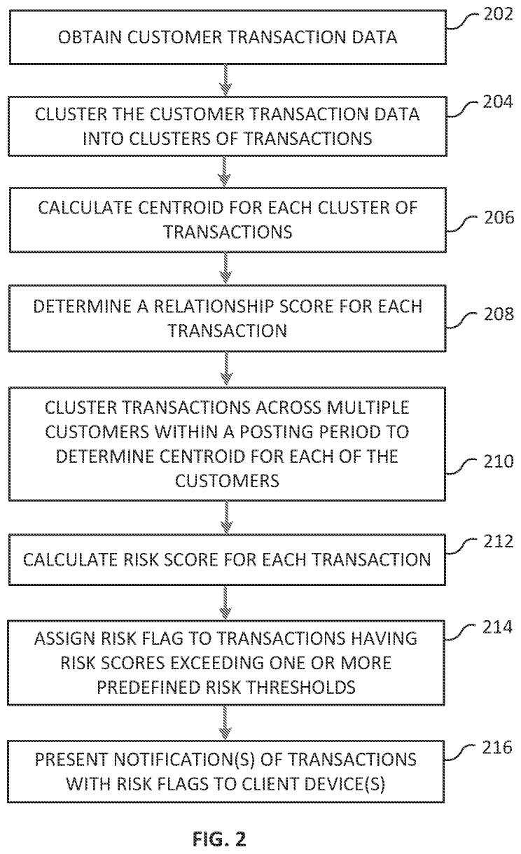

In one or more embodiments, processing engine 102 may perform the exemplary method of FIG. 2 or other method herein and, as a result, provide cross-cluster transaction risk assessment. In some embodiments, this may be accomplished via communication with the client device(s) 106, database storage 104, and/or other device(s) over a network between the device(s) and an application server or some other network server. In some embodiments, the processing engine 102 is an application, browser extension, or other piece of software hosted on a computer or similar device, or is itself a computer or similar device configured to host an application, browser extension, or other piece of software to perform some of the methods and embodiments herein.

Within the processing engine 102, data retrieval module 110 functions to obtain customer transaction data from external sources, facilitating the ingestion of critical data for analysis. In some embodiments, the module is configured to establish connections with various data providers, which may include, e.g., financial institutions, businesses, or other entities that generate and store transaction data. Through secure communication protocols, the Data Retrieval Module gathers a diverse range of transaction details, such as, e.g., transaction amounts, dates, types, and customer identities, depending on the specific requirements of the system. In some embodiments, the module can retrieve data from multiple sources.

Clustering module 112 functions to categorize this customer transaction data into meaningful clusters, using one or more clustering algorithms to determine transaction patterns. In some embodiments, the clustering module 112 employs one or more distance-based clustering algorithms. The module analyzes the transaction details, such as, e.g., transaction amounts, dates, and types, and employs mathematical techniques to determine the similarity or dissimilarity between transactions. It then segregates transactions into clusters based on their inherent characteristics. Each cluster represents a group of transactions that share common attributes. In some embodiments, each cluster is formed around a common shared customer, and within a specific posting period or window of time. In some embodiments, that posting period may be prespecified by a user or administrator within the system.

Centroid module 114 functions to calculate a “centroid” for each cluster, which serves as a central reference point denoting the mean value within that cluster. In some embodiments, this module employs one or more statistical methods to compute the centroid for each cluster, essentially identifying the mean value for various transaction attributes within that cluster. These attributes may include, e.g., transaction amounts, dates, types, and other pertinent details. The calculated centroids serve as reference points that capture the typical behavior or characteristics of transactions within their respective clusters.

Relationship scoring module 116 functions to assign relationship scores to individual transactions, characterizing their deviation from the centroid and gauging their risk potential. In some embodiments, these relationship scores serve as a quantitative measure of how far or near a particular transaction is from the centroid of its cluster. In some embodiments, to calculate these scores, the module employs a mathematical formula that takes into account the transaction's attributes and their deviation from the cluster's typical behavior, as represented by the centroid. In some embodiments, the module assesses the distance or variation of each transaction from the cluster's mean values, capturing the extent of its anomaly within that specific group. By computing these relationship scores, the system gains valuable insights into the uniqueness of each transaction within its cluster, and also facilitates the identification of potential anomalies, as transactions deviating significantly from their cluster's centroid are more likely to be flagged as higher-risk transactions during the subsequent risk assessment process.

These relationship scores are then synthesized into risk assessments through the risk assessment module 118, which employs a multifaceted approach to assess transaction risk. In some embodiments, this module is responsible for evaluating and quantifying the risk associated with each transaction under analysis. Using the relationship scores generated by the relationship scoring module 116, the module considers multiple factors, including, e.g., the transaction's proximity to the centroid of its cluster, the variations within the cluster, and/or the transaction's relationship with centroids of other clusters across different customers. The assessment process results in a risk score for each transaction, which reflects the likelihood of it being an anomaly or posing a risk. In some embodiments, the risk scores are then subjected to further normalization processes to ensure comparability across different transactions and customers. In some embodiments, transactions that surpass predefined risk thresholds are flagged as potential areas of concern, and their details are subsequently presented to users of client devices as notifications for further review and action.

Notification module 120 functions to present one or more risk notifications to user(s) of one or more client devices, in order to facilitate timely awareness and action regarding flagged transactions. In some embodiments, the module generates one or more notifications that contain information regarding transactions that have been flagged as potentially risky. These notifications are transmitted to one or more client devices associated with users who need to be informed about these transactions. In some embodiments, the module has the capability to prioritize the notifications based on the ranking of transactions' risk scores, ensuring that the most critical alerts are delivered promptly. The notifications may include detailed information about, e.g., the transactions, their risk scores, and/or any relevant contextual data. Additionally, in some embodiments, this module can be configured to support customizable notifications, allowing users to receive information in a format or medium that suits their preferences, such as, for example, visual representations, reports, or other communication means.

In some embodiments, client device(s) 106 are one or more computing devices that are connected to a computer network. A computing device generally refers to any hardware device that includes a processor. A computing device may refer to a physical device executing an application or a virtual machine. Examples of computing devices include, e.g., a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (“NAT”), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

In some embodiments, each of the client device(s) are associated with a respective set of computing resources. Computing resources may comprise, e.g., software and/or hardware resources used in the execution of one or more applications by the associated host. Example computing resources may include, e.g., central processing units (“CPUs”), network ports, database connections, user sessions, memory, operating systems, application instances, and virtual machine instances. Additionally or alternatively, a host may include other computing resources, which may vary from one host to the next. In some embodiments, the processing engine 102 may be hosted in whole or in part as an application or web service executed on the client device(s) 106. In some embodiments, one or more of the database storage 104, processing engine 102, and client device(s) 106 may be the same device.

In various embodiments, database storage 104 constitutes optional repositories which can include one or more of, e.g., a repository for customer transaction data 122, which stores transaction details essential for risk assessment; transaction repository 124, which stores historical transaction data for customers; and customer repository 126, which stores customer information. This optional functionality contributes to the system's ability to assess transaction risk taking context from multiple customers into account. The optional database(s) may also store and/or maintain any other suitable information for the processing engine 102 to perform elements of the methods and systems herein. In some embodiments, the optional database(s) can be queried by one or more components of system 100 (e.g., by the processing engine 102), and specific stored data in the database(s) can be retrieved.

In some embodiments, one or more components of system 100, including processing engine 102, may be implemented as or integrated into a cloud service, such as a software-as-a-service (“SaaS”) or a platform-as-a-service (“PaaS”). Additional embodiments and examples pertaining to cloud services are described below in Section 5, titled Computer Networks and Cloud Networks.

### 3. Cross-Cluster Transaction Risk Assessment

FIG. 2 illustrates an example set of operations for providing cross-cluster transaction risk assessment, in accordance with some embodiments. One or more operations illustrated in FIG. 2 may be modified, rearranged, or omitted all together. Accordingly, the particular sequence of operations illustrated in FIG. 2 should not be construed as limiting the scope of one or more embodiments.

Referring to FIG. 2, at operation 202, the process obtains customer transaction data, including a number of transaction details. The process begins by first acquiring transaction data from one or more sources. This data encompasses a multitude of transaction details, which are used to assess the risk associated with customer transactions.

In some embodiments, the transaction details involve large datasets with numerous variables, each contributing to the overall assessment of risk. In some embodiments, this step is not limited to a specific industry or type of transaction; instead, it may potentially be adapted to various domains and for different applications.

In various embodiments, the “customer transaction data” may include a wide array of information, such as, for example, transaction amount, transaction date, transaction type, and customer identity. These transaction details may be used to develop an understanding of a corresponding transaction's context and characteristics. Transaction amount represents the monetary value associated with each transaction. By considering transaction amounts, the method can gauge the financial significance of each transaction, helping to identify anomalies or discrepancies that may indicate risk. For example, an unusually large transaction amount for a customer who typically conducts smaller transactions could raise a red flag. Transaction date specifies when each transaction occurred. Examining transaction dates allows the method to identify patterns and trends over time. For example, sudden spikes in transactions on specific dates might be indicative of irregular behavior, which could be a potential risk factor. Transaction type provides information about the nature of the transaction, such as whether it involves, e.g., a purchase, a transfer, or a different action. Distinguishing between transaction types helps the method understand the context of each transaction, as different types may have varying risk profiles. For example, a large withdrawal from a bank account may be normal, while a large unauthorized transfer could signal a risk. Customer identity is an attribute that associates each transaction with a specific customer or account holder. Customer identity is vital for tracking individual behavior and identifying risks associated with particular customers. For example, unusual activity within a specific customer's transactions may trigger a risk flag, indicating the need for further investigation.

At operation 204, the process clusters the customer transaction data into clusters of transactions based on the transaction details. This operation functions to group similar transactions together. Clustering, as used herein, is a data segmentation technique used to identify patterns or similarities within a dataset. In this context, the customer transactions, which includes a multitude of transaction details, is subjected to clustering algorithms. In various embodiments, these algorithms make use of various transaction attributes, such as, e.g., transaction amount, transaction date, transaction type, and customer identity to group transactions with shared characteristics. The goal of this clustering process is twofold. First, it reduces the complexity of analyzing individual transactions by categorizing them into meaningful clusters. Second, it facilitates the identification of transaction anomalies by highlighting deviations from the norm within each cluster. For instance, if most transactions within a cluster have similar transaction amounts and types, an outlier with an unusually large transaction amount may be flagged as an anomaly.

In some embodiments, the choice of clustering algorithm can depend on the nature of the data and the specific objectives of the risk assessment, while in other embodiments, one clustering algorithm is used regardless of the nature of the data or the specific objectives. In various embodiments, common clustering methods may include, for example, K-means clustering, hierarchical clustering, and Density-Based Spatial Clustering of Applications with Noise (“DBSCAN”). In some embodiments, the selection of the most suitable algorithm depends on factors such as, for example, the dataset's size, dimensionality, and the expected structure of the clusters.

In some embodiments, the process normalizes a transaction value for each of the transactions within each cluster. This normalization process ensures that the risk assessment is not biased by extreme or disproportionate transaction values, thus contributing to the accuracy of the risk scoring mechanism. The process first identifies the transactions within each cluster. Once the transactions are categorized into clusters based on their shared transaction details, the process functions to transform the transaction values within each cluster into a standardized format that facilitates equitable comparison and risk assessment.

Normalization is used in statistical analysis and data processing to bring data points onto a common scale. Within the present context, normalizing transaction values within clusters serves the purpose of reducing the impact of outliers or extreme values that might skew the risk assessment. By adjusting these values to a standard scale, the method ensures that the relative significance of each transaction's value within its cluster is appropriately considered.

In various embodiments, the normalization process may employ a variety of methods, such as, e.g., scaling techniques or logarithmic transformations. In some embodiments, the choice of normalization method can be tailored to the specific needs and characteristics of the transaction data under evaluation.

In some embodiments, the process clusters the customer transaction data by applying a distance-based clustering algorithm. Distance-based clustering algorithms, including but not limited to K-means or Hierarchical Clustering, rely on measuring the dissimilarity or distance between data points to form clusters. In the specific context of customer transaction data, this entails grouping transactions with similar characteristics or patterns into clusters.

Distance-based clustering is a data analysis method used to group data points into clusters based on their similarity or dissimilarity. In some embodiments, this form of clustering starts with data preparation, selecting a distance metric appropriate for the data, and initializing cluster centroids. Data points are then assigned to the nearest cluster centroid, and centroids are updated based on the data points in each cluster. This assignment and update process iterates until a stopping condition is met, resulting in the final clustering.

At operation 206, the process calculates a centroid for each cluster of transactions, the centroid representing a transaction corresponding to a mean value within the corresponding cluster. This operation functions to condense the information within each cluster into a single representative transaction. To achieve this, the system computes a centroid for each cluster by determining the mean value of transaction attributes within that particular cluster. By calculating the mean, the system may establish a central transaction within the cluster that serves as a reference point for evaluating the entire cluster.

Consider, for example, a cluster of transactions related to a specific customer during a particular time frame. The centroid for this cluster would be a transaction that embodies the average transaction amount, date, and type for that customer during that period. This approach encapsulates the collective behavior of transactions within the cluster, effectively summarizing their characteristics.

In some embodiments, the process calculates a centroid for each cluster by determining a statistical mean of transaction attributes within the corresponding cluster. In some embodiments, this calculation method includes determining a statistical mean, often referred to as the average, of these transaction attributes within the cluster. The transaction attributes encompass key parameters like transaction amount, transaction date, transaction type, and customer identity, which collectively contribute to the characterization of the cluster.

In some embodiments, when calculating the centroid, the process assesses these transaction attributes within the cluster to derive their mean values. For example, in a cluster of transactions related to a particular product type, it calculates the average transaction amount, the average transaction date, the most common transaction type, and other pertinent statistics. By taking these average values, it essentially identifies a transaction within that cluster that best represents the cluster as a whole. This centroid can then serves as a reference point for further calculations.

At operation 208, the process determines, for each transaction, a relationship score indicating the distance of the transaction from the centroid of its cluster. The relationship score serves as a quantitative measure indicating the distance of the transaction from the centroid of its respective cluster.

In some embodiments, the process determines the relationship score by employing a mathematical formula that quantifies the transaction's deviation from the centroid. In some embodiments, the formula considers various transaction attributes, and calculates a numerical value that reflects how far the transaction lies from the cluster's centroid. This value represents the transaction's relationship score.

The relationship score is an essential metric for evaluating the significance of a transaction within its cluster. Transactions with low relationship scores are typically close to the centroid, signifying that they align closely with the typical behavior of the cluster. Conversely, transactions with high relationship scores are distant from the centroid, suggesting that they deviate significantly from the cluster's norm. The determination of relationship scores serves as a fundamental building block for subsequent analysis and risk assessment. It allows the system to identify transactions that exhibit outlier behavior within their respective clusters, potentially indicating unusual or high-risk activities. These relationship scores become critical in the system's ability to differentiate between typical and atypical transactions.

In some embodiments, the relationship score for each transaction is calculated using a mathematical formula that considers the transaction's distance from the centroid and the variation within the cluster. This formula takes into account two factors: the transaction's distance from the centroid of its cluster, and the degree of variation observed within that cluster.

In some embodiments, when calculating the relationship score, the algorithm factors in the spatial separation between the transaction under assessment and the centroid of its respective cluster. This distance measurement is used to gauge how distinct or anomalous the transaction is within the cluster context. A transaction that is closely aligned with the cluster's centroid would typically exhibit a lower distance and consequently a more favorable relationship score, indicating that it closely resembles the typical behavior within that cluster.

In some embodiments, the formula considers the variation within the cluster. It assesses how dispersed or concentrated the transaction attributes are within the cluster. A cluster with minimal attribute variation would yield a more consistent and predictable environment, influencing the relationship score calculation accordingly.

At operation 210, the process clusters transactions across multiple customers within a posting period to determine a centroid for each of the customers. This operation functions to group transactions based on various criteria, including customer attributes such as, e.g., industry type, transaction volume, and transaction frequency, within a defined posting period, which represents a specific time frame for assessing transaction risk. In some embodiments, transactions occurring within the same posting period are aggregated and classified into clusters according to shared attributes or characteristics. These clusters are essentially collections of transactions that exhibit similar patterns, behaviors, or attributes during the designated posting period. For example, transactions from customers in a particular industry sector, like banking or retail, may form distinct clusters.

In some embodiments, once these clusters are established, the method calculates a centroid for each of the customers. The centroid for a customer represents a central point or mean within the cluster of transactions associated with that customer. Calculating these centroids involves determining a statistical mean or average of transaction attributes within each customer's cluster. The rationale behind deriving centroids for individual customers lies in the need to understand and assess transaction behavior specific to each customer within the given posting period. This customer-centric approach enables the system to account for variations in behavior and risk across different customers, which is especially valuable in contexts where customers may have unique characteristics and transaction patterns. The customer-centric centroids serve as reference points for subsequent risk assessment steps.

In some embodiments, the process identifies the posting period for the transactions, the posting period reflecting a time frame for assessing the risk. The posting period allows the method to contextualize the transactions and evaluate them based on a specific timeframe. In various embodiments, transaction data can vary significantly over time due to, e.g., seasonality, behavioral trends, or other external factors. For example, what might be considered a risky transaction during one posting period could be entirely normal during another. The identification of the posting period enables the method to make precise risk assessments by accounting for these temporal variations.

In some embodiments, the process clusters transactions across multiple customers by grouping transactions based on customer attributes selected from the group consisting of industry type, transaction volume, and transaction frequency. In some embodiments, the process begins with collecting transaction data, selecting relevant attributes, and using a clustering algorithm to form clusters of similar transactions. Each cluster has a centroid representing the average attributes within it. This attribute-based clustering aids in more precise risk assessment and pattern identification for different customer segments.

In some embodiments, the process clusters transactions across multiple customers by refining one or more of the clusters using customer-specific attributes and transaction histories. By doing so, it can create more precise clusters of transactions, which can lead to more accurate risk assessments. In various embodiments, customer-specific attributes may include details such as, e.g., industry type, transaction volume, transaction frequency, and any other relevant information that distinguishes one customer from another. Transaction histories refer to the past transaction patterns and behaviors of each customer. By considering these factors, the process can better identify patterns, anomalies, and potential risks within a specific customer's transactions. For example, it may be more sensitive to unusual transaction patterns for a high-frequency trader compared to a customer with a different profile.

At operation 212, the process calculates a risk score for each transaction by evaluating the transaction's relationship scores against the centroid of the corresponding cluster and the centroids of the other clusters. In some embodiments, once transactions are assigned to their respective clusters based on shared attributes or customer-specific criteria, each transaction is assessed in terms of its relationship to the centroid of its cluster. The relationship score, which signifies the distance between the transaction and its cluster's centroid, plays a central role in this evaluation. A transaction's relationship score provides a quantitative measure of how similar or dissimilar it is to the typical behavior of the transactions within its own cluster. A transaction that is significantly distant from its cluster's centroid may be considered an outlier or anomaly within that cluster.

However, the risk assessment process goes beyond evaluating a transaction solely within the context of its own cluster. It incorporates a broader perspective by considering the centroids of other clusters as well. This multi-dimensional evaluation enables a comprehensive understanding of the transaction's behavior relative to all customers and clusters during the specified posting period.

In some embodiments, the calculation of a risk score integrates these relationship scores into a unified measure of risk associated with each transaction. This measure is not limited to a transaction's relationship with its own cluster but encompasses its relationship with the centroids of all other clusters. This holistic approach ensures that the risk score reflects the transaction's deviation from the expected behavior of all customers, taking into account their unique characteristics and patterns. In essence, the risk score serves as a quantifiable indicator of the transaction's risk level within the context of the entire dataset. Transactions that significantly deviate from the expected behavior, both within their own clusters and compared to other clusters, are assigned higher risk scores. Conversely, transactions that closely align with expected behavior receive lower risk scores.

By considering both intra-cluster and cross-cluster deviation, the process may adapt, in an unsupervised fashion, to evolving patterns indicative of anomalous transaction behavior. For example, a data point representing a particular transaction may not deviate significantly from other intra-cluster data points. However, if all other customer clusters with similar profiles have data points that have significantly shifted within the same timeframe, then the inter-cluster deviation may be significant. As a result, the process may flag a transaction that is not anomalous in the isolated context of the customer if it is anomalous in a holistic context based on the detected trend relative to similar clusters. Conversely, the data points that may appear anomalous in isolation may not be flagged if consistent with the trend across customer clusters. Stated another way, the process represents an unsupervised machine learning technique that does not rely on static and explicitly programmed risk assessment rules. The unsupervised machine learning algorithm allows the computing system to identify patterns not previously encountered by a database system during application runtime, make data-driven assessments of transactions within the database system, and adapt to new data in real-time. The unsupervised learning process is scalable to big data environments, such as datacenters and cloud computing platforms, which may receive thousands or millions of transactions within a relatively short period of time. The process may assess and process such high volumes of transactions in real-time or near real-time while adapting to new patterns of behavior to prevent or mitigate the effect of harmful behavior in these environments.

In some embodiments, the risk score for each transaction is normalized based on a normalized transaction value for the transaction. In some embodiments where the transaction values within each cluster have been standardized, the risk scores for individual transactions are computed based on these normalized values. This normalization-based risk scoring ensures that the relative significance of each transaction within its cluster is accurately reflected in the final risk assessment.

In some embodiments, normalizing the risk score includes applying a logarithmic transformation to accentuate variations in risk scores. The logarithmic transformation functions to refine the risk assessment by accentuating variations in risk scores. In some embodiments, the process compresses the range of risk scores to account for transaction data that may exhibit a wide spectrum of risk levels. This transformation ensures that risk scores are not only normalized based on transaction values but also adjusted to better highlight distinctions between various transactions within a cluster.

In some embodiments, normalizing the transaction values is performed using a standardized scaling technique. This functions to bring uniformity to the range and distribution of transaction values within each cluster. In some embodiments, it operates by transforming the transaction values in a way that centers them around a mean of zero with a standard deviation of one. By utilizing standardized scaling, the method ensures that each transaction's value is adjusted relative to the statistical characteristics of the cluster it belongs to.

In some embodiments, the process calculates the risk score by applying a weighted combination of the transaction's relationship scores relative to its cluster and the centroids of the other clusters. In some embodiments, the process calculates the relationship scores for the transaction within its cluster. These scores reflect how much the transaction deviates from the cluster's central tendency, indicating its level of anomaly within its specific context. The process then evaluates how the transaction relates to the centroids of all the clusters, not just its own. In some embodiments, these clusters are combined in a manner that assigns relative importance to each component. This weighting enables flexibility in determining the risk score, allowing adjustments based on the specific characteristics and requirements of the dataset and risk assessment criteria.

In some embodiments, the process utilizes historical transaction data to establish baseline risk scores for comparison with current transactions. In some embodiments, this historical data includes transaction details, such as, e.g., transaction amounts, dates, types, and customer identities. By analyzing this historical data, the system can calculate baseline risk scores, which serve as a reference point for evaluating the risk associated with current transactions. Baseline risk scores provide a benchmark against which the risk level of new transactions can be assessed. In some embodiments, transactions that deviate significantly from the established baseline may be flagged as potential outliers or high-risk transactions.

At operation 214, the process assigns a risk flag to transactions having risk scores exceeding one or more predefined risk thresholds. The assignment of risk flags is guided by predefined risk thresholds, one or more of which are established to categorize transactions into varying levels of risk. These predefined risk thresholds serve as critical benchmarks against which each transaction's calculated risk score is compared. The risk score, representing the degree of deviation or anomaly exhibited by the transaction concerning expected behavior, is assessed against these thresholds. Transactions with risk scores that exceed one or more of these predefined thresholds are identified as being of heightened concern or elevated risk.

In some embodiments, the use of multiple predefined risk thresholds allows for a nuanced classification of transactions based on their risk levels. In some embodiments, each threshold may correspond to a specific risk category or level, such as, e.g., low, moderate, high, or critical risk. In some embodiments, the specific thresholds and their associated risk categories can be tailored to align with the risk appetite and requirements of the organization or system implementing this method. This adaptability ensures that the risk assessment can be customized to suit different industry types, customer profiles, or risk management strategies.

Upon identifying transactions that surpass these predefined risk thresholds, the method proceeds to assign risk flags to these transactions. These risk flags serve as clear indicators of the assessed risk level associated with each transaction. For example, transactions exceeding a moderate risk threshold may receive a corresponding risk flag denoting their moderate-risk status. Similarly, transactions surpassing a high-risk threshold may be flagged as high-risk transactions.

In some embodiments, the predefined risk thresholds are determined based on user-defined criteria tailored to specific industry types. Different industries may have distinct risk tolerance levels and characteristics. Consequently, the process allows users to define and customize these risk thresholds based on their industry-specific criteria. This customization recognizes that what constitutes a high-risk transaction in one industry might be standard practice in another. In some embodiments, individuals or organizations utilizing the system have the flexibility to set these thresholds according to their specific needs and risk management policies. For instance, in the financial sector, where transactions involve substantial sums of money, the risk thresholds may be set at different levels compared to the retail industry.

In some embodiments, the process prioritizes risk flags based on a ranking of transactions' risk scores. The process incorporates a mechanism that ranks transactions based on their risk scores. This ranking considers the calculated risk scores for each transaction, which are determined by evaluating their relationship scores against the centroids of clusters and other clusters. By prioritizing risk flags, the system ensures that high-risk transactions receive immediate attention, allowing organizations to focus their resources and efforts on assessing and mitigating the most critical risks. This prioritization aligns with best practices in risk management, where timely action on high-priority risks can prevent potentially severe consequences.

In some embodiments, assigning a risk flag includes labeling transactions with categories of risk levels based on predefined score ranges. In some embodiments, the categorization is done based on the risk scores calculated for each transactions. These risk scores are evaluated against predefined score ranges or thresholds.

At operation 216, the process presents one or more notifications of the transactions with risk flags to one or more client devices associated with users. These notifications serve as a means of communicating the assessed risk levels and relevant information about flagged transactions to the users or relevant parties. In some embodiments, the notifications are designed to be informative and actionable, providing users with the necessary details to make informed decisions regarding the flagged transactions. In various embodiments, the notifications may include a variety of information, such as, e.g., the nature of the transaction, the associated risk score, the risk flag assigned, and any additional contextual information that aids in understanding the basis for the risk assessment.

In some embodiments, the presentation of notifications is a dynamic process that takes into account the specific user preferences and roles associated with each client device. Users may have varying degrees of authority or responsibility within the system, and the notifications can be tailored to align with their roles and needs. For example, notifications presented to compliance officers may include detailed information about flagged transactions to facilitate regulatory compliance checks, while notifications to individual users may focus on transaction-specific details.

In various embodiments, users may receive notifications through a variety of channels, including, e.g., web-based interfaces, mobile applications, email, or other communication platforms. In some embodiments, the choice of presentation format can be configured to accommodate the preferences of users and the requirements of the organization or system.

In some embodiments, notifications include actionable elements, allowing users to take immediate steps in response to flagged transactions. For example, users may be provided with options to, e.g., review flagged transactions, request additional information, or initiate further investigations.

In some embodiments, the process presents the one or more notifications by delivering visual representations of one or more of: risk scores of transactions, clusters of transactions, and centroids of the clusters. These notifications are intended to convey information about flagged transactions, particularly regarding their risk levels. In some embodiments, the process may visually display the risk scores associated with individual transactions. This visual representation aids users in promptly assessing the risk level associated with each flagged transaction, thereby enabling more informed decision-making. In some embodiments, the process visually displays clusters of transactions. These clusters are established based on the similarity of transaction details. Visualizing these clusters can assist users in identifying patterns and trends within their data, potentially revealing insights into common risk factors. In some embodiments, the process visually displays market trend centroids of transactions. These centroids signify the mean values of transactions within clusters and across multiple customers. Visualizing these centroids can provide users with insights into overall market trends and how their transactions align with these trends.

In some embodiments, the process presents, to at least a subset of the client devices, a user interface that facilitates manual review of the flagged transactions. This user interface is designed to facilitate the manual review of flagged transactions. In various embodiments, it can serve as a practical tool for users, such as, e.g., financial analysts, risk managers, or other relevant personnel, to interact with the system's findings. It allows them to review flagged transactions in more detail, potentially gather additional information, and make informed decisions about how to address each flagged transaction.

### 4. Risk Assessment Process Example

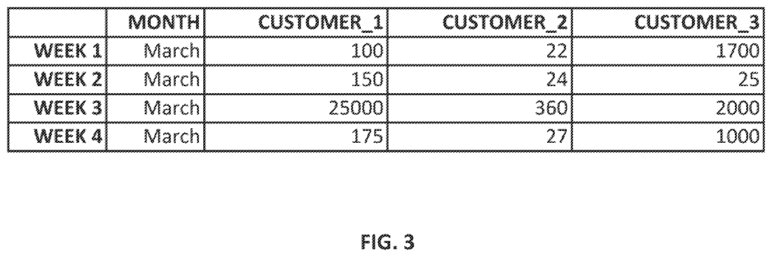

FIG. 3 illustrates an example diagram of a risk assessment process being performed for a set of transactions in accordance with some embodiments. The example diagram represents a simplified example of a risk assessment process for a set of transactions involving three different customers over the course of a month. Each row in the chart corresponds to a specific month, and each column represents a different customer (in this case, CUSTOMER_1, CUSTOMER_2, and CUSTOMER_3). The values within the chart represent transaction data, specifically the transaction volumes for each customer in that particular month.

The “MONTH” column signifies the time frame for which the risk assessment is being conducted. In this example, it's for the month of March. The “CUSTOMER_1,” “CUSTOMER_2,” and “CUSTOMER_3” columns represent different customers involved in various transactions during different periods in March. The numerical values within each cell of the chart represent the transaction volumes for each customer in that particular month. In the first week of March, CUSTOMER_1 had 100 transactions, CUSTOMER_2 had 22 transactions, and CUSTOMER_3 had 1,700 transactions. In the second week of March, the customers had 150, 24, and 25 transactions, respectively. In the third week of March, the customers had 25,000, 360, and 2,000 transactions, respectively. In the fourth week of March, the customers had 175, 27, and 1,000 transactions, respectively.

In this example, the risk assessment process might involve several steps. It would typically start with data retrieval and clustering, where transactions are grouped together based on common characteristics such as transaction type, amount, and date. In this case, the transactions have already been aggregated for each customer in the chart. Next, the system might calculate centroids for these clusters, determining the mean transaction volume within each cluster. This centroid calculation helps in understanding typical transaction behavior for each customer. The relationship scores between individual transactions and their respective centroids would be computed. Transactions significantly deviating from their cluster's centroid might be flagged as potentially risky. Clustering transactions across multiple customers would allow the system to identify unusual behavior not just within a single customer's transactions but also in comparison to other customers.

The system would assign risk scores to each transaction based on these relationship scores, and transactions exceeding predefined risk thresholds would receive risk flags. These flags could trigger notifications to be sent to client devices associated with users, alerting them to potentially risky transactions.

### 5. ADAPTIVE ATTACK PREVENTION AND MITIGATION

In some embodiments, the system is configured to implement one or more attack prevention or mitigation actions based on the risk assessment model outputs. For example, the system may use the output scores to filter or sort a list of customer accounts based on the severity and/or volume of risky transactions associated with each account. Additionally or alternatively, the system may selectively enable or disable security measures on an account-by-account basis based on the predicted risk scores.

The security measures that are enabled or disabled may vary and be configurable by a system administrator. In some embodiments, the system may lock an account and/or block a transaction if one or more transactions have a risk score exceeding a threshold. The system may send a one-time password to the user. The account may remain locked and the transactions blocked until the password is received from the user to confirm the activity. Other example security measures may include selectively enabling two-part authentication, blocking an IP address associated with a transaction, preventing a database transaction from committing until further review, running a vulnerability scan on an account, and/or configuring security settings on the account to thwart a predicted attack or minimize the damage of an attack in progress.

In some embodiments, the system compares risk assessment scores for one or more new transactions associated with an account to one or more thresholds. If the one or more thresholds are satisfied, then the system may trigger one or more of the adaptive attack prevention and mitigation actions. For example, the system may compare the average risk score and/or the number of transactions above a risk score to a threshold. If the one or more thresholds are satisfied, then the system may enable one or more of the extra security measures previously mentioned.

In some embodiments, administrators may configure the thresholds and/or actions taken by a system address a predicted attack. For example, the administrator may define a rule to block a transaction from committing to a database if the risk assessment score exceeds a threshold until it is approved by an administrator on the user account. When offending transactions are detected by the unsupervised process in FIG. 2, then the rule may be triggered, thereby blocking the transaction, which may then be added to a review queue. The administrator may subsequently review transactions on the queue, blocking or approving the transactions on an individual or group basis. Additionally or alternatively, the administrator may define a rule that blocks transactions outright without further review if the risk assessment score exceeds a threshold to minimize the amount of manual review for transactions that the system confidently classifies as anomalous.

### 6. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

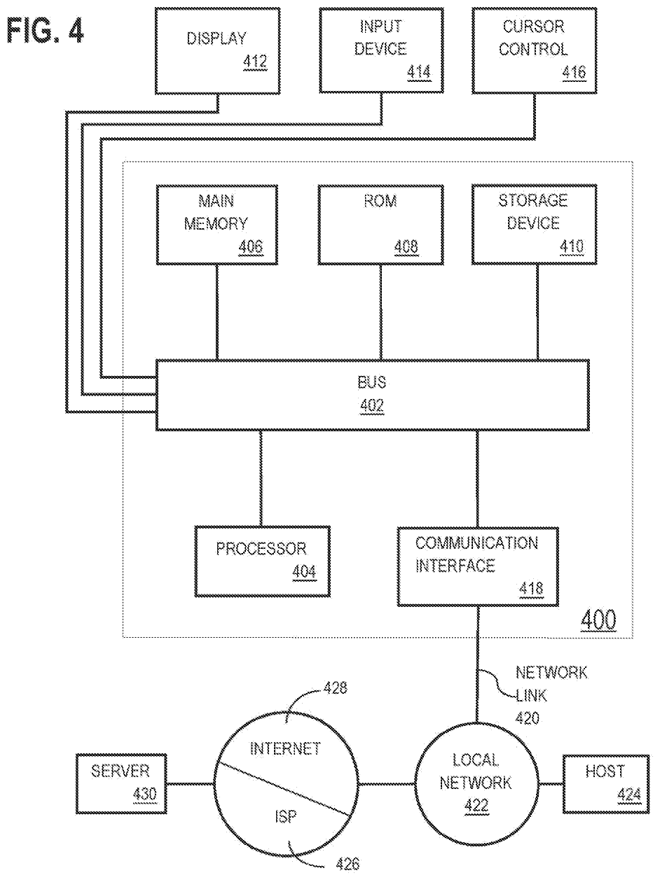

For example, FIG. 4 illustrates a computer system upon which some embodiments may be implemented. Computer system 400 includes a bus 402 or other communication mechanism for communicating information, and a hardware processor 404 coupled with bus 402 for processing information. Hardware processor 404 may be, for example, a general-purpose microprocessor.

Computer system 400 also includes a main memory 406, such as a random-access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic, or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic, or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 7. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
obtaining customer transaction data comprising a plurality of transaction details;
clustering the customer transaction data into clusters of transactions based on the transaction details;
calculating a centroid for each cluster of transactions, the centroid representing a transaction corresponding to a mean value within the corresponding cluster;
determining, for each transaction, a relationship score indicating the distance of the transaction from the centroid of its cluster;
clustering transactions across multiple customers within a posting period to determine a centroid for each of the customers;
calculating a risk score for each transaction by evaluating the transaction's relationship scores against the centroid of the corresponding cluster and the centroids of the other clusters;
assigning a risk flag to transactions having risk scores exceeding one or more predefined risk thresholds; and
presenting one or more notifications of the transactions with risk flags to one or more client devices associated with users.

2. The method of claim 1, further comprising:
normalizing a transaction value for each of the transactions within each cluster.

3. The method of claim 2, wherein the risk score for each transaction is normalized based on the normalized transaction value for the transaction.

4. The method of claim 3, wherein normalizing the risk score includes applying a logarithmic transformation to accentuate variations in risk scores.

5. The method of claim 2, wherein normalizing the transaction values is performed using a standardized scaling technique.

6. The method of claim 1, further comprising:
identifying the posting period for the transactions, the posting period reflecting a time frame for assessing the risk.

7. The method of claim 1, wherein the customer transaction data comprises transaction attributes, the transaction attributes comprising one or more of: transaction amount, transaction date, transaction type, and customer identity.

8. The method of claim 1, wherein clustering the customer transaction data further comprises applying a distance-based clustering algorithm.

9. The method of claim 1, wherein calculating a centroid for each cluster includes determining a statistical mean of transaction attributes within the corresponding cluster.

10. The method of claim 1, wherein the relationship score for each transaction is calculated using a mathematical formula that considers the transaction's distance from the centroid and the variation within the cluster.

11. The method of claim 1, wherein clustering transactions across multiple customers further comprises grouping transactions based on customer attributes selected from the group consisting of industry type, transaction volume, and transaction frequency.

12. The method of claim 1, wherein calculating the risk score involves applying a weighted combination of the transaction's relationship scores relative to its cluster and the centroids of the other clusters.

13. A system comprising:
at least one device including a hardware processor;
the system being configured to perform operations comprising:
obtaining customer transaction data comprising a plurality of transaction details;
clustering the customer transaction data into clusters of transactions based on the transaction details;
calculating a centroid for each cluster of transactions, the centroid representing a transaction corresponding to a mean value within the corresponding cluster;
determining, for each transaction, a relationship score indicating the distance of the transaction from the centroid of its cluster;
clustering transactions across multiple customers within a posting period to determine a centroid for each of the customers;
calculating a risk score for each transaction by evaluating the transaction's relationship scores against the centroid of the corresponding cluster and the centroids of the other clusters;
assigning a risk flag to transactions having risk scores exceeding one or more predefined risk thresholds; and
presenting one or more notifications of the transactions with risk flags to one or more client devices associated with users.

14. The system of claim 12, wherein the predefined risk thresholds are determined based on user-defined criteria tailored to specific industry types.

15. The system of claim 12, wherein the system is further configured to perform an operation comprising:
prioritizing risk flags based on a ranking of transactions' risk scores.

16. The system of claim 12, wherein presenting the one or more notifications includes delivering visual representations of one or more of: risk scores of transactions, clusters of transactions, and centroids of the clusters.

17. The system of claim 12, wherein the system is further configured to perform an operation comprising:
utilizing historical transaction data to establish baseline risk scores for comparison with current transactions.

18. The system of claim 12, wherein assigning a risk flag comprises labeling transactions with categories of risk levels based on predefined score ranges.

19. The system of claim 12, wherein the system is further configured to perform an operation comprising:
presenting, to at least a subset of the client devices, a user interface that facilitates manual review of the flagged transactions.

20. The system of claim 12, wherein clustering transactions across multiple customers comprises refining one or more of the clusters using customer-specific attributes and transaction histories.

21. A non-transitory computer-readable medium containing instructions comprising:
obtaining customer transaction data comprising a plurality of transaction details;
clustering the customer transaction data into clusters of transactions based on the transaction details;
calculating a centroid for each cluster of transactions, the centroid representing a transaction corresponding to a mean value within the corresponding cluster;
determining, for each transaction, a relationship score indicating the distance of the transaction from the centroid of its cluster;
clustering transactions across multiple customers within a posting period to determine a centroid for each of the customers;
calculating a risk score for each transaction by evaluating the transaction's relationship scores against the centroid of the corresponding cluster and the centroids of the other clusters;
assigning a risk flag to transactions having risk scores exceeding one or more predefined risk thresholds; and
presenting one or more notifications of the transactions with risk flags to one or more client devices associated with users.
